(19) United States
(12) Patent Application Publication
(10) Pub. No.: US 2010/0134858 A1
(43) Pub. Date: Jun. 3, 2010

(54) IMAGE SCANNING DEVICE AND CALIBRATION METHOD THEREOF

(75) Inventors: Katsushi MINAMINO, Kyoto-shi (JP); Kouji NAKAMURA, Kyoto-shi (JP)

Correspondence Address: MURATA MACHINERY, LTD.;(MURATEC) c/o KEATING & BENNETT LLP, 1800 Alexander Bell Drive, SUITE 200, Reston, VA, 20191, US

(73) Assignee: MURATA MACHINERY, LTD., Kyoto-shi (JP)

(21) Appl. No.: 12/618,804

(22) Filed: Nov. 16, 2009

(30) Foreign Application Priority Data
Dec. 3, 2008 (JP) 2008-308348

(51) Int. Cl. H04N 1/46

(52) U.S. Cl. 358/504

(57) ABSTRACT

Ina calibration method of an image scanning device, an original for use calibration including a plurality of patches each having a different tone is scanned, scanned tone values of the patches of the original are acquired with respect to each of a plurality of color components, a curve function is acquired with respect to each of the plurality of color components based on the scanned tone values and target tone values of the patches predetermined with respect to each of the plurality of color components, each curve function approximating a relationship between an input defined as the scanned tone value and an output defined as the target tone value, and the curve function is acquired with respect to each of the plurality of color components such that input value intercepts, each being defined as an upper limit of a range of the input value in which range the output value is maintained at zero, are equal among the plurality of color components.

### CROSS-REFERENCE TO RELATED APPLICATIONS

This application claims priority under 35 U.S.C. 119 to Japanese Patent Application No. 2008-308348, filed on Dec. 3, 2008, which application is hereby incorporated by reference in its entirety.

### BACKGROUND OF THE INVENTION

1. Field of the Invention

The present invention relates to an image scanning device that can acquire a scanned image by separating an original into three color components (such as a Red component, a Green component, and a Blue component (RGB)), for example.

2. Description of the Related Art

A conventional digital color copier typically includes a Charge Coupled Device (CCD) line image sensor as an image acquiring unit, and scans an image of light reflected from an original as analog signals that are represented in an RGB color coordinate system. Image data of the analog signals scanned by the CCD line image sensor is transmitted to an Analog Front End (AFE) and converted into digital data. The image data output from the AFE is defined as multi-valued image data representing an R component, a G component, and a B component of each pixel in an 8 bit format.

Such a conventional digital color copier typically includes a calibration mode. In the calibration mode, the copier scans a sheet on which a test image printed by the copier is recorded through the CCD line image sensor, and performs an Analog-to-Digital conversion (A/D conversion) on the scanned data through the AFE to acquire test image data in an RGB color coordinate system. By performing a matrix transform process, etc. on the test image data, such test image data can be converted into an Lab color coordinate system. Then, by comparing the acquired test image data with data that was used when printing the test image, a correction parameter for correcting the scanned image data is calculated.

An original that is used in such a calibration operation (i.e., an original for use in calibration or a test chart) needs to be printed with accurate density in order to eliminate individual differences among the image scanning devices. However, when generating the original for use in calibration in appropriate color and density especially in a low-intensity tone, a great density needs to be printed which thereby increases cost.

### SUMMARY OF THE INVENTION

In order to overcome the problems described above, preferred embodiments of the present invention provide a tone correcting function that excels particularly in low-intensity tone reproducibility in an image scanning device.

According to a preferred embodiment of the present invention, an image scanning device preferably includes a scanning unit, a patch tone value acquiring unit, a correction function acquiring unit, and a correction unit. The scanning unit is arranged to scan an original. When an original for use in calibration including a plurality of patches each having a different tone, is scanned by the scanning unit, the patch tone value acquiring unit is arranged to acquire scanned tone values of the patches with respect to each of three color components. The correction function acquiring unit is arranged to acquire a curve function with respect to each of the three color components based on target tone values of the patches predetermined with respect to each of the three color components and on the scanned tone values, each curve function approximating a relationship between an input defined as the scanned tone value and an output defined as the target tone value. The correction unit is arranged to correct the tone values of each of the color components of an image acquired by scanning the original by the scanning unit based on the curve functions. The correction function acquiring unit then determines the curve function of each of the three color components such that input value intercepts, each being defined as an upper limit of a range of the input value in which range the output value is maintained at zero, are equal among the three color components.

In the above configuration, since the input value intercepts are common to the curve functions of the three color components, in particular, a portion in a low-intensity tone of the image including gray balance can be faithfully reproduced. Further, without particularly increasing the number of patches at the portion in the low-intensity tone, a calibration operation can be performed accurately and with excellent results. Furthermore, output characteristics of the scanned portion can be accurately corrected through the curve functions. Therefore, a tone correcting operation can be performed accurately and with excellent results even with few patches.

According to a preferred embodiment of the present invention, the image scanning device preferably includes a curve function determining unit. The curve function determining unit is arranged to determine a curve function with respect to a specified color component which is any one of the three color components, and to acquire curve functions with respect to the color components other than the specified color component such that each of the curve functions for the other color components has the input value intercept of the determined curve function as the input value intercept. With this configuration, the curve functions having the respective input value intercepts that are common to the three color components can be acquired with a simple calculation operation.

According to a preferred embodiment of the present invention, the correction function acquiring unit preferably includes a curve function candidate acquiring unit, a disruption degree acquiring unit, and a curve function determining unit. The curve function candidate acquiring unit is arranged to acquire a curve function candidate with respect to each of a plurality of input value intercept candidates for the specified color component which is any one of the three color components, each curve function candidate having the corresponding input value intercept candidate as the input value intercept. With respect to each of the plurality of input value intercept candidates for the specified color component, the disruption degree acquiring unit is arranged to acquire a disruption degree in the situation where the corresponding curve function candidate is used to approximate the relationship between the scanned tone values and the target tone values of the patches. The curve function determining unit selects the input value intercept candidate that derives a minimum disruption degree, and determines the curve function candidate that corresponds to the selected input value intercept candidate as the curve function for the specified color component. The curve function determining unit is arranged to acquire curve functions with respect to the other color components than the specified color component such that each of the curve functions for the other color components has the selected input value intercept candidate as the input value intercept.

With the above configuration, the curve function that achieves the highest approximation accuracy can be acquired with respect to the specified color component. Even when the three color components are comprehensively considered, the curve functions having the respective input value intercepts that are common to the three color components can also be acquired with good color reproducibility (such as gray balance, for example) through a simple calculation operation.

According to a preferred embodiment of the present invention, the correction function acquiring unit preferably includes the curve function candidate acquiring unit, the disruption degree acquiring unit, and the curve function determining unit. The curve function candidate acquiring unit is arranged to acquire a curve function candidate with respect to each of the plurality of input value intercept candidates for each of the three color components, each curve function candidate having the corresponding input value intercept candidate as the input value intercept. With respect to each of the plurality of input value intercept candidates for each of the three color components, the disruption degree acquiring unit is arranged to acquire a disruption degree in the situation where the corresponding curve function candidate is used to approximate the relationship between the scanned tone values and the target tone values of the patches. The curve function determining unit is arranged to select the input value intercept candidate that derives a minimum disruption degree in the whole three color components, and to determine the curve function candidate that corresponds to the selected input value intercept candidate as the curve function.

With the above configuration, while matching the input value intercepts among the three color components, the curve function that achieves the highest approximation accuracy can be acquired by comprehensively considering the three color components. As a result, the quality of the scanned image can be further improved. When using an exponent function as the curve function, an approximation equation can be acquired in consideration of the reproducibility of the portion in a low-intensity tone.

According to a preferred embodiment of the present invention, the disruption degree acquiring unit preferably acquires a square sum of errors between output values as the disruption degree, which are the scanned tone values of the patches input to the corresponding curve function candidate, and the target tone values of the patches. With this configuration, the approximation accuracy of the curve function candidate with respect to the data acquired by scanning the patches can be appropriately evaluated. Therefore, the most appropriate input value intercept candidate (curve function candidate) can be reliably selected, and image data faithfully reproducing the original can be acquired.

According to a preferred embodiment of the present invention, the curve function candidate acquiring unit is preferably arranged to acquire the curve function candidate through a least-square method based on the scanned tone values of the patches acquired by the patch tone value acquiring unit and on the target tone values of the patches. With this configuration, since the curve function with high accuracy can be acquired, the image data faithfully reproducing the original can be acquired.

In the image scanning device including the scanning unit that can acquire the tone values of each of the three color components by scanning the original, a preferred embodiment of the present invention provides the following calibration method. That is, the calibration method of the image scanning device preferably includes a step of scanning, a step of acquiring a patch tone value, and a step of acquiring a correction function. In the step of scanning, the scanning unit scans an original for use in calibration including a plurality of patches each having a different tone. In the step of acquiring the patch tone value, scanned tone values of the patches of the original for use in calibration can be acquired with respect to each of the three color components. In the step of acquiring the correction function, a curve function is acquired with respect to each of the three color components based on the scanned tone values and target tone values of the patches predetermined with respect to each of the three color components, each curve function approximating a relationship between an input defined as the scanned tone value and an output defined as the target tone value. In the step of acquiring the correction function, the curve function of each of the three color components is determined such that input value intercepts, each being defined as an upper limit of a range of the input value in which range the output value is maintained at zero, are equal among the three color components.

Since the curve functions for the three color components acquired by the above method have the respective input value intercepts that are common to the three color components, in particular, a portion in a low-intensity tone of an image can be faithfully reproduced including gray balance. Moreover, without particularly increasing the number of patches at the portion in the low-intensity tone, a calibration operation can be performed accurately and with excellent results. Furthermore, output characteristics of the scanning unit can be accurately corrected through the curve functions. Therefore, a tone correcting operation can be performed accurately and with excellent results even with few patches.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a cross-sectional view of an entire image scanner device according to a preferred embodiment of the present invention.

FIG. 2 is a block diagram illustrating an electrical configuration of the image scanner device according to a preferred embodiment of the present invention.

FIG. 3 is a flowchart of a main flow of a calibration operation of the image scanner device according to a preferred embodiment of the present invention.

FIG. 4 illustrates a test chart for use in calibration according to a preferred embodiment of the present invention.

FIG. 5 represents equations that are used when acquiring a curve function (exponent function) that approximates a relationship between scanned tone values and target tone values.

FIG. 6 is a flowchart illustrating a process of acquiring parameters of a curve function candidate that corresponds to an input value intercept candidate.

FIG. 7 is a flowchart illustrating a process of acquiring a square sum of errors with respect to the acquired curve function candidate.

FIG. 8 conceptually illustrates, with respect to each of RGB components, a plurality of input value intercept candidates and curve function candidates acquired based on the respective input value intercept candidates.

FIG. 9 is a flowchart illustrating a process of selecting, from the plurality of input value intercept candidates, the input value intercept candidate that derives the highest data approximation accuracy by the corresponding curve function candidate.

FIG. 10 is a flowchart illustrating a process of acquiring image information by scanning an original by the image scanner device.

FIG. 11 represents an equation that is used to generate a tone correction table.

FIG. 12 is a flowchart illustrating a process of generating the tone correction table.

FIG. 13 illustrates a modified example of equations.

FIG. 14 illustrates equations that are used to acquire a curve function in the modified example in which a polynomial function is used as the curve function.

### DETAILED DESCRIPTION OF PREFERRED EMBODIMENTS

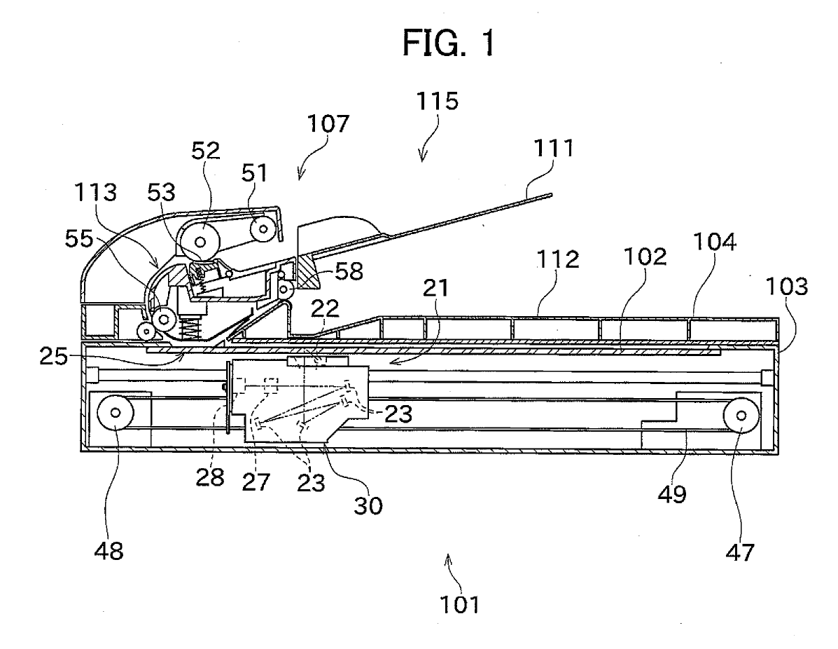

Preferred embodiments of the present invention will now be described. FIG. 1 is a cross-sectional view illustrating an entire configuration of an image scanner device 101 according to a preferred embodiment of the present invention.

As illustrated in FIG. 1, the image scanner device 101 defined as an image scanning device preferably includes an image scanning unit 115 having an Auto Document Feeder (ADF) and a flatbed.

The configuration of the image scanner device 101 will be described in detail. The image scanner device 101 preferably includes an original table 103 and an original table platen cover 104. The original table 103 preferably includes a platen glass 102 on which originals are placed. The original table platen cover 104 supports the originals such that the originals are pressed onto the platen glass 102. The image scanner device 101 preferably includes an operation panel (not shown) that is arranged to allow a user to input instructions to start scanning of the originals, or the like.

An ADF 107 is preferably arranged on the original table platen cover 104. The ADF 107 preferably includes an original tray 111 arranged at an upper portion of the original table platen cover 104 and a document discharge tray 112 arranged below the original tray 111.

As illustrated in FIG. 1, a curved original transporting path 113 is preferably provided inside the original table platen cover 104 to connect the original tray 111 to the document discharge tray 112. The original transporting path 113 preferably includes a pick-up roller 51, a separation roller 52, a separation pad 53, a feed roller 55, and a paper exit roller 58.

The pick-up roller 51 is arranged to pick up the original placed on the original tray 111. The separation roller 52 and the separation pad 53 are arranged to separate the picked-up originals one sheet at a time. The feed roller 55 is arranged to feed the separated original to an original scanning position 25. The paper exit roller 58 is arranged to discharge the scanned original to the document discharge tray 112.

In the above configuration, the originals stacked and placed on the original tray 111 are separated one sheet at a time, fed along the curved original transporting path 113, and pass through the original scanning position 25. Then, after being scanned by a later-described scanner unit 21, the originals are discharged onto the document discharge tray 112.

As illustrated in FIG. 1, the scanner unit 21 is preferably provided in the original table 103. The scanner unit 21 preferably includes a carriage 30 that can move inside the original table 103.

The carriage 30 preferably includes a fluorescent lamp 22 as a light source, reflection mirrors 23, a convergence lens 27, and a scanning sensor (preferably, a CCD line image sensor, for example) 28. The fluorescent lamp 22 is arranged to irradiate the original with light. The light reflected from the original is reflected by the plurality of reflection mirrors 23 and passes through the convergence lens 27. Then, the reflected light is converged and focused into an image on a surface of the scanning sensor 28. The scanning sensor 28 converts the incoming convergent light into an electric signal and then outputs the signal.

In the present preferred embodiment, a three-line color CCD line image sensor is preferably used as the scanning sensor 28, for example. The scanning sensor 28 preferably includes elongated one-dimensional line sensors extending in a main scanning direction (i.e., in a width direction of the original). The one-dimensional line sensors are preferably provided for colors, Red, Green, and Blue (RGB), respectively, for example. The scanning sensor 28 also includes different color filters that correspond to the respective line sensors. Thus, image information of the original can be scanned by being separated into three colors of RGB.

A drive pulley 47 and an idler pulley 48 are preferably rotationally supported inside the original table 103. An endless drive belt 49 is preferably wound around the drive pulley 47 and the idler pulley 48, and the carriage 30 is preferably fixed to a suitable position of the drive belt 49. In the above configuration, by forwardly or reversely driving and rotating the drive pulley 47 by an electric motor (not shown), the carriage 30 is arranged to travel horizontally along a sub scanning direction.

In the above configuration, the carriage 30 is moved in advance to a position that corresponds to the original scanning position 25, and then, the ADF 107 is driven. Accordingly, the original being transported through the original transporting path 113 is scanned at the original scanning position 25. The light which has been radiated by the fluorescent lamp 22 and reflected by the original is introduced into the carriage 30, and further introduced into the scanning sensor 28 by the reflection mirrors 23 through the convergence lens 27 so as to be focused into an image. Thus, the scanning sensor 28 outputs an electric signal in accordance with the scanned content.

When using the image scanner device 101 as a flatbed scanner, the original placed on the platen glass 102 is scanned while the carriage 30 is moved along the platen glass 102 at a prescribed speed. The reflection light from the original is similarly introduced into the scanning sensor 28 of the carriage 30 and focused into an image.

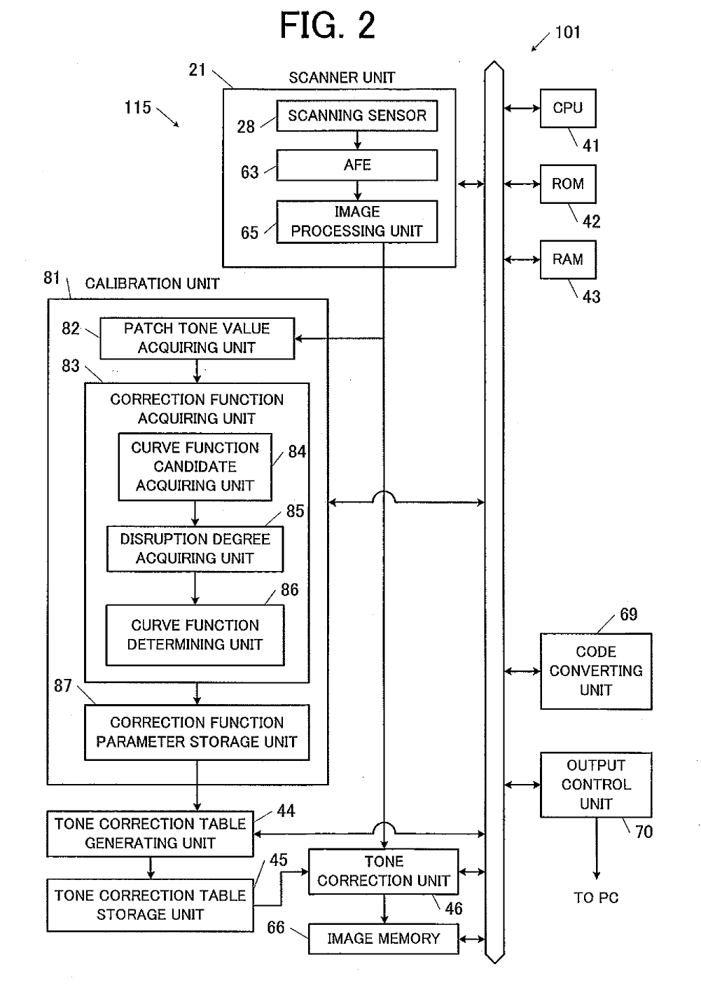

FIG. 2 is a block diagram of the image scanner device 101. As illustrated in FIG. 2, in addition to the scanner unit 21, the image scanner device 101 preferably includes a Central Processing Unit (CPU) 41 as an arithmetic unit, a Read Only Memory (ROM) 42, and a Random Access Memory (RAM) 43, both provided as storage units.

The image scanner device 101 preferably further includes a tone correction table generating unit 44, a tone correction table storage unit 45, atone correction unit (correcting unit) 46, an image memory 66, a code converting unit 69, an output control unit 70, and a calibration unit 81.

The CPU 41 is preferably provided as a control unit arranged to control the scanner unit 21, the tone correction unit 46, the output control unit 70, and the calibration unit 81 and/or other elements and operations of the image scanner device 101. Programs and data, etc. used in the above control operation are stored in the ROM 42 provided as the storage unit. The RAM 43 is used to temporarily store data that is necessary when executing the above programs, or the like.

The scanner unit 21 preferably includes an AFE 63, which is connected with the scanning sensor 28. When scanning the original, the RGB line sensors of the scanning sensor 28 scan one line of the original in the main scanning direction. A signal from each of the line sensors is converted from an analog signal to a digital signal by the AFE 63. In this main scanning operation, one line of pixel data is output as RGB tone values from the AFE 63. By repeating the above process while the original or the carriage 30 is gradually transported in the sub scanning direction, image data of the entire original can be acquired as digital signals.

The scanner unit 21 preferably includes an image processing unit 65, and the digital signals of the image data output from the AFE 63 are input into the image processing unit 65. The image processing unit 65 is arranged to perform shading correction on the pixel data that is input one line at a time per main scanning operation, and corrects scanned unevenness arising from an optical system of the scanner unit 21. The image processing unit 65 is also arranged to perform correction on the pixel data to correct color displacement caused by arrangement intervals (line gaps) of the RGB line sensors in the scanning sensor 28.

The image memory 66 stores the image (i.e., RGB tone values of each pixel) scanned by the scanner unit 21.

The tone correction table generating unit 44 is arranged to generate data of a tone correction table that is used when performing the tone correction on the image data scanned by the scanner unit 21. When generating the tone correction table, curve functions (i.e., correction functions to be described later) acquired by the calibration unit 81 are used. The content of the table generated by the tone correction table generating unit 44 is stored in the tone correction table storage unit 45.

The tone correction unit 46 corrects the image data output by the scanner unit 21, based on the tone correction table. Thus, by correcting non-linearity of the output of the scanning sensor 28 with respect to the intensity of the input light, or the like, a scanned image that is faithfully reproduced from the original can be acquired. The image corrected by the tone correction unit 46 is input to and stored in the image memory 66.

By performing a compression operation such as, for example, a Joint Photographic Experts Group (JPEG), the code converting unit 69 encodes the image data stored in the image memory 66.

The output control unit 70 transmits the coded image data to a Personal Computer (PC) provided as a higher-level device connected with the image scanner device 101. Any desirable transmission method may be selected, and, for example, a method using a Local Area Network (LAN) and a method using a Universal Serial Bus (USB) may preferably be used.

The calibration unit 81 is arranged to generate curve functions (tone correction functions) based on an image that has been acquired by scanning, by the scanner unit 21, a given test chart (to be described later) provided as an original used in calibration, and the calibration unit 81 stores (update) parameters of the curve functions. The calibration unit 81 preferably includes a patch tone value acquiring unit 82, a correction function acquiring unit 83, and a correction function parameter storage unit 87.

The patch tone value acquiring unit 82 acquires, through calculation, RGB component values (scanned tone values) acquired by scanning a plurality of gray patches of the test chart.

The correction function acquiring unit 83 acquires the curve functions (correction functions) through calculation, each curve function approximating a relationship between the scanned tone values acquired by the patch tone value acquiring unit 82 and predetermined target tone values of the gray patches. The correction function acquiring unit 83 preferably includes a curve function candidate acquiring unit 84, a disruption (deviation) degree acquiring unit 85, and a curve function determining unit 86.

The curve function candidate acquiring unit 84 is arranged to generate, as a curve function candidate (i.e., a correction function candidate), the curve function that approximates the relationship between the scanned tone values acquired by scanning the gray patches and the target tone values of the gray patches. The curve function is generated with respect to each of the RGB components (i.e., the curve function candidate acquiring unit 84 generates the curve function for R component, the curve function for G component, and the curve function for B component). A plurality of curve function candidates, which will be described later in detail, are generated such that each of the curve function candidates has different prescribed parameters.

The disruption degree acquiring unit 85 is arranged to acquire, through calculation, a value (disruption degree) that evaluates an approximation accuracy with which such curve function candidate approximates the relationship between the actual scanned tone values and the target tone values. The evaluation value of the approximation accuracy is calculated with respect to each of the curve function candidates for each of the RGB components.

By comprehensively considering the approximation accuracy in each of the RGB components, the curve function determining unit 86 selects the curve function candidates that can approximate the relationship between the actual tone values and the target tone values with the highest accuracy. Then, the curve function determining unit 86 determines the selected curve function candidates as the curve functions (correction function) that will be used for correction.

The correction function parameter storage unit 87 is arranged to store the parameters of the curve function (correction function) acquired by the correction function acquiring unit 83. The parameters of the correction function are referred to when the tone correction table generating unit 44 generates the tone correction table.

In the present preferred embodiment, the image processing unit 65, the tone correction table generating unit 44, the tone correction unit 46, the calibration unit 81, and the code converting unit 69 or the like are preferably realized by using hardware such as, for example, an Application Specific Integrated Circuit (ASIC) and a Field Programmable Gate Array (FPGA). By writing an image processing program, which performs a scanner calibration operation (to be described later), in the ASIC or the like, a scanner calibration function of the calibration unit 81 can be realized. Alternatively, the calibration unit 81, etc., may be realized by a combination of the CPU 41 and a program, or the like.

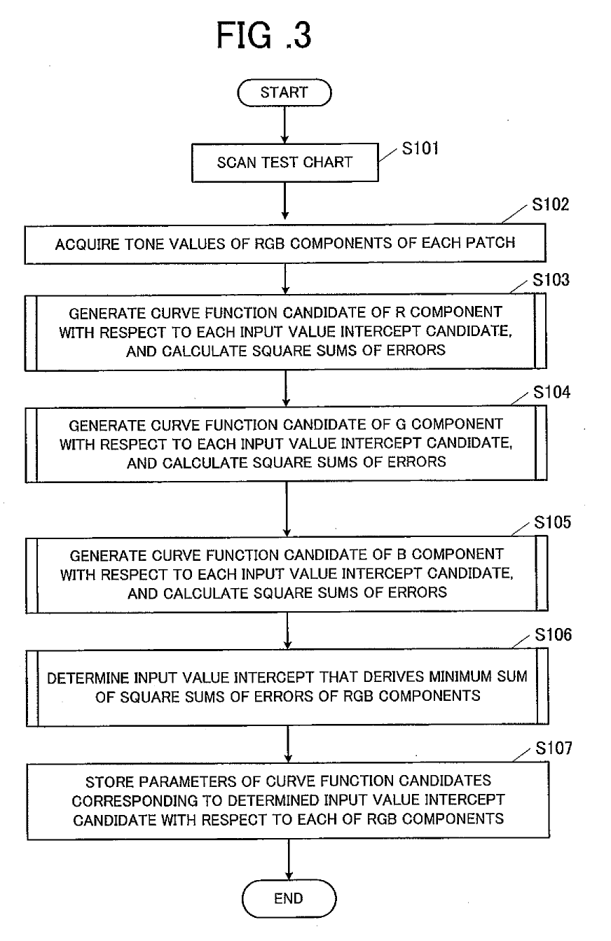

Next, the scanner calibration operation by the calibration unit 81 will be described with reference to FIG. 3. FIG. 3 represents a main flow that is executed when a user operates the operation panel of the image scanner device 101 to perform a calibration operation.

When the main flow of FIG. 3 is started, a message prompting the user to place a test chart is displayed on the operation panel. In accordance with the message, the user places a prepared test chart on the original tray 111 or the platen glass 102 of the image scanner device 101.

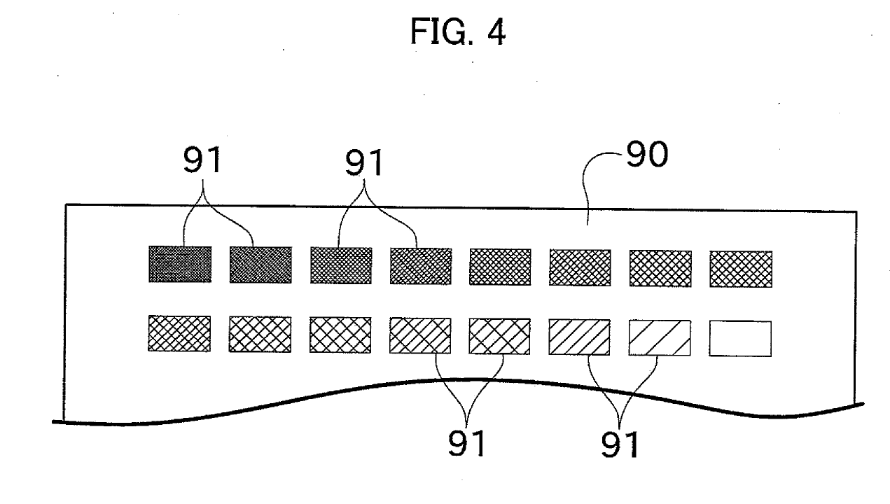

An example of the test chart is illustrated in FIG. 4. A test chart 90 has a plurality of rectangular gray patches 91 aligned at prescribed positions. Density of the gray patches 91 is accurately managed and printed, and therefore, by performing the calibration operation with the test chart 90, differences among the image scanner devices 101 regarding the scanned tone values can be reduced. In the example of FIG. 4, 16 gray patches 91 are preferably arranged in two rows (i.e., eight gray patches 91 are arranged in an upper row and eight gray patches 91 are arranged in a lower row). In the following description, reference numerals No. 0, No. 1, No. 2, . . . may sequentially refer to the gray patches 91 from the left towards the right in the upper row, and then from the left towards the right in the lower row.

Each of the plurality of gray patches 91 has a tone that is different in a phased manner from No. 0, which has the darkest tone, to No. 15, which has the lightest tone, and the tones (density) gradually become lighter in numerical order. For convenience of description of the drawings, the gray tone of the gray patches 91 are represented by different hatchings.

In the test chart 90, tone values (hereinafter, referred to as target tone values) that should be acquired when each of the gray patches 91 is scanned are predetermined with respect to each of the RGB components. For example, the target tone values that should be acquired when the gray patch No. 0 is scanned are (R, G, B)=(0, 0, 0), and the target tone values of the gray patch No. 1 are (R, G, B)=(10, 10, 10). The target tone values are predetermined based on colorimetric values (L*a*b*, XYZ) of each of the gray patches 91 of the test chart 90. A relationship between each of the gray patches 91 and the corresponding target tone values is previously stored in a memory such as the ROM 42 of the image scanner device 101.

The user places the test chart 90 of FIG. 4 on the image scanner device 101 and instructs the start of scanning. Accordingly, the test chart 90 is scanned by the scanner unit 21 (scanning step, S101 of FIG. 3).

When a scanned image of the test chart 90 is acquired, the patch tone value acquiring unit 82 analyzes the scanned image to acquire the scanned tone value of each of the gray patches 91 with respect to each of the RGB components (patch tone value acquiring step, S102). More specifically, the patch tone value acquiring unit 82 extracts, as samples, a plurality of pixels existing in an area of each of the gray patches 91 from the scanned image of the test chart 90, and calculates an average tone value of the extracted pixels with respect to each of the RGB components. Thus, the acquired average values are determined as the actual scanned tone values of the corresponding gray patch 91.

In the above process, a set (xi, yi) of the actual scanned tone value “xi” and the target tone value “yi” can be acquired with respect to each of the 16 gray patches 91 from No. 0 through No. 15 and also with respect to each of the RGB components.

Next, the curve function (correction function) that approximates the above relationships of (xi, yi) is acquired with respect to each of the RGB components in the processes of S103 through S107.

First, a plurality of input value intercept candidates c0, c1, c2, . . . cn, which are common to the RGB components, are predetermined and stored in a suitable storage unit or the like of the ASIC, for example. The input value intercept is an upper limit of a range of an input value “x” in which range an output value “y” is maintained at zero in a corresponding curve function “y=f(x)”. In other words, in the curve function used in the present preferred embodiment, when the input value “x” is zero, the output value “y” is also zero, and even when the input value “x” increases from zero, the output value “y” is maintained at zero as long as the input value “x” is less than or equal to a prescribed value (upper limit) “c”. The input value intercept “c” is the prescribed upper limit of the corresponding curve function.

The curve function candidate is acquired through a least-square method with respect to each of the plurality of input value intercept candidates c0, c1, c2, . . . , cn for each of the RGB components, each curve function candidate having the corresponding input value intercept candidate as the input value intercept. Then, a disruption degree (i.e., a square sum of errors in the present preferred embodiment) in the situation where the acquired curve function candidate is used to approximate the relationships of (xi, yi) is calculated. The above processes correspond to the processes of S103 through S105 (S103 for the R component, S104 for the G component, and S105 for the B component).

Next, the input value intercept candidate is acquired (S106) which derives a minimum sum of the disruption degrees (square sums of the errors) of the corresponding curve function candidates of the RGB components in the situation where such curve function candidates are used to approximate the relationships of (xi, yi), and the curve function candidates that correspond to the determined input value intercept candidate are adopted as the curve functions (correction function acquiring step, S107).

Next, a detailed description will be made of a process (S103) of acquiring the curve function candidate and evaluating the approximation accuracy of the acquired candidate for the R component.

It is now assumed that “xi” defines the R component scanned value (i.e., the scanned tone value of the R component acquired by the patch tone value acquiring unit 82) acquired when the “i”th gray patch 91 of the test chart 90 is scanned, and “yi” defines the R component target tone value of the “i”th gray patch 91. In a situation where the gray patches No. 0 through No. m are provided, (m+1) sets of data of (xi, yi) can be acquired for the R component. In the test chart 90 of FIG. 4, since the largest number of the gray patch 91 is 15, “m=15”.

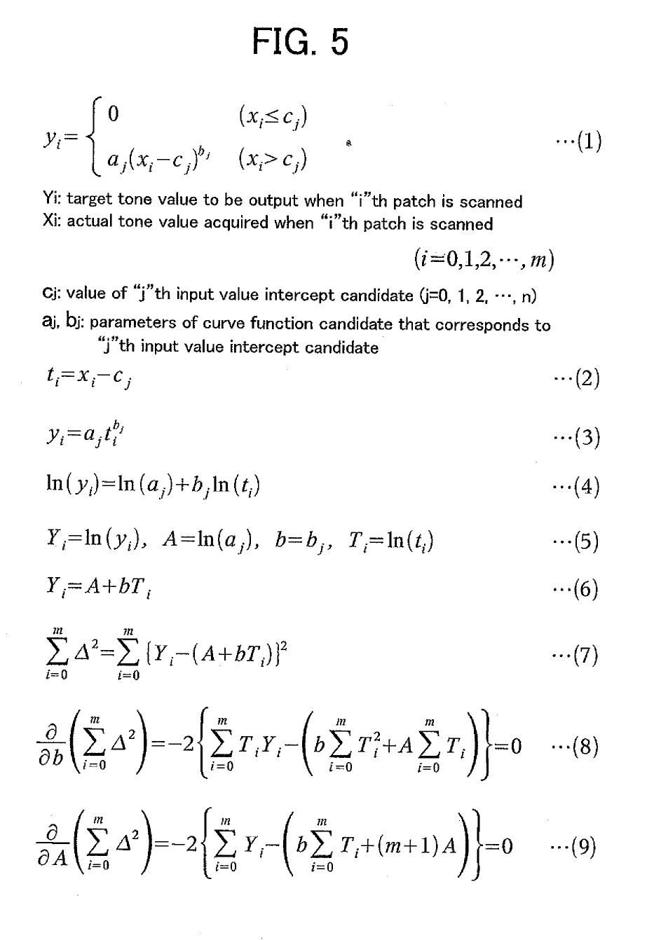

Next, it is assumed that the curve function (exponent function) of an equation (1) of FIG. 5 is used to approximate the (m+1) sets of data of (xi, yi) (i=0, 1, 2, . . . , m). The input value intercept candidates “c0” through “cn”, i.e., (n+1) input value intercept candidates are given as the input value intercept “cj” in the equation (1). In the present preferred embodiment, the curve function candidate is acquired with respect to each of the input value intercept candidates. When acquiring the curve function candidate, parameters “aj” and “bj” of the curve function candidate of the equation (1) are acquired.

In the present preferred embodiment, the parameters “aj” and “bj” are calculated as follows. First, a variable “ti” of an equation (2) is substituted into an equation that is represented on a lower side of the equation (1). As a result, the equation (1) can be replaced with a simple relationship of “yi” and “ti” as represented in an equation (3). Then, by applying a logarithm natural to the equation (3), an equation (4) can be obtained. In order to further simplify the equation, by introducing relationships that are represented in an equation (5), an equation (6) is obtained.

As described above, in the present preferred embodiment, each of the curve function candidates is obtained by the least-square method. Since the logarithm natural is a monotonically increasing function, when an error “Δ” between “ln(P)” and “ln(Q)” becomes minimum, an error “δ” between “P” and “Q” also becomes minimum. Accordingly, in the present preferred embodiment, the logarithm natural is applied to each of the sets of data (xi, yi), and by acquiring the parameters “aj” and “bj” that derive a minimum square sum of the errors “Δ” of the logarithm naturals, least squares approximation by the exponent function can be achieved with the simple calculations.

More specifically, the calculations are performed as follows. That is, (Ti, Yi) that corresponds to the respective sets of data (xi, yi) is calculated in accordance with the equations (2) and (5), and the (Ti, Yi) is approximated by the equation (6). At this time, the square sum of the errors “Δ” can be acquired by an equation (7) of FIG. 5.

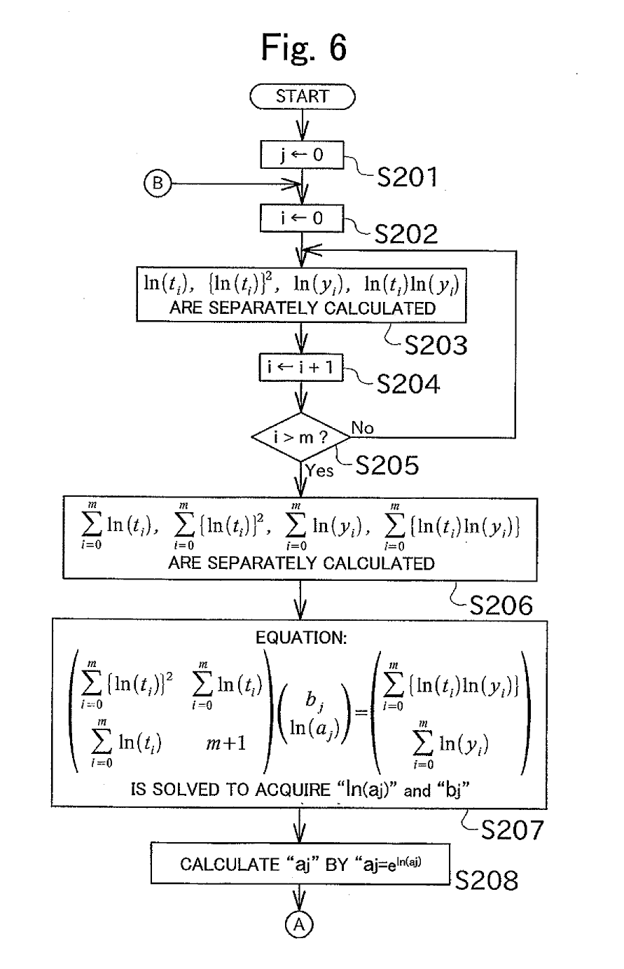

It is assumed that when “A” and “b” are variables in the equation (7), the equation (7) has an extremum. When a value of the equation (7) becomes minimum, the equation (7) in which each of the variables is partially differentiated is set at zero. Thus, equations (8) and (9) are obtained. By representing the equations (8) and (9) in determinant, and by applying the relationships of the equation (5) to restore the variables, an equation represented in S207 of FIG. 6 is obtained. By calculating an inverse matrix of a matrix that is multiplied by “bj, ln(aj)” on the left-hand side in the determinant, “bj” and “ln(aj)” can be acquired.

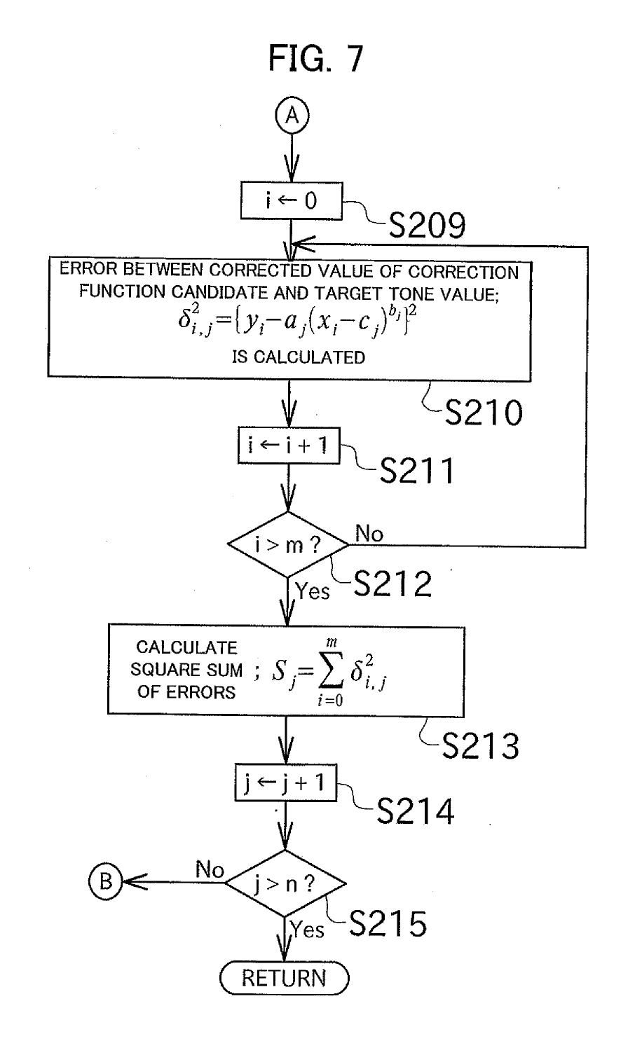

The above calculations are performed while a sub routine of FIGS. 6 and 7 is executed, and the flow thereof will now be described in detail. The subroutine is common to and can be called at the steps S103 through S105 of the main routine of FIG. 3.

Next, a process of the sub routine called at step S103 of the main routine (i.e., the sub routine called when processing the R component of the RGB components) will be described. When the flow of FIG. 6 is started, first, a value of a loop variable “j” is initialized to zero (S201), and then, a value of a loop variable “i” is initialized to zero (S202). The reference marks of the loop variables “i” and “j” correspond to that of the equation (1) of FIG. 5. That is, “i” denotes the number of the gray patch 91, and “j” denotes the number of the input value intercept candidate.

Next, while increasing the value of the loop variable “i” one by one from “0” to “m”, “ln(ti)”, “{ln(ti)}²”, “ln(yi)”, and “ln(ti)ln(yi)” are separately calculated with respect to the actual scanned tone value “xi” and the target tone value “yi” of the R component (S203 through S205). Thus, values that are necessary in the later-described calculations, such as the logarithm natural of the target tone value “yi”, or the like, can be acquired with respect to each of the gray patches 91. Then, using the above calculation results, prescribed sums that are necessary for solving the determinant of S207 are separately calculated (S206).

By solving the above least squares equation by a matrix calculation, values of “ln(aj)” and “bj” are separately acquired (S207), and further, a value of “aj” is calculated (S208). Thus, the parameters “aj” and “bj” of the curve function candidate corresponding to the input value intercept candidate “cj” can be acquired for the R component. The acquired parameters “aj” and “bj” are stored in a suitable storage unit.

In the sub routine, the square sum of the errors in the situation where the curve function candidate, which has been defined by the parameters “aj”, “bj” and the input value intercept candidate “cj”, is used to approximate the data (xi, yi) of the R component is acquired (S209 through S212 of FIG. 7).

More specifically, the value of the loop variable “i” is initialized to zero (S209), and then, while increasing the value of the loop variable “i” one by one from “0” to “m”, each error between the target tone value “yi” of the “i”th gray patch 91 and an output value which is the actual scanned tone value “xi” of the “i”th gray patch 91 input to the curve function candidate is squared (δi, j²), and the squared errors are stored in a suitable storage unit (S210 through S212). Then, each of the squared errors calculated with respect to each of the gray patches is added, and thus acquired value “Sj” is stored in the RAM (S213). Thus, the square sum “Sj” of the errors of the R component in the situation where the curve function candidate of the R component acquired in the processes S202 through S208 is used to approximate the data can be acquired. The acquired value of the square sum “Sj” is stored in a suitable storage unit.

Then, one is added to the value of the loop variable “j” (S214), and when the value of “j” does not exceed “n” (i.e., the maximum number of the input value intercept candidate), the process returns to S202 (S215). By repeating this process, while increasing the value of the loop variable “j” one by one from “0” to “n”, the curve function candidate (parameters “aj” and “bj”) of the R component with the “j”th input value intercept candidate “cj” can be acquired, and the square sum “Sj” of the errors in the situation where the corresponding curve function candidate is used for approximation can also be acquired. When the above repeating process is completed, the process returns to the main routine of FIG. 3.

Next, the curve function candidates respectively corresponding to the input value intercept candidates “c0”, “c1”, “c2”, . . . “cn” are acquired for the G component, and the square sum “Sj” of the errors of each of the curve function candidates is also calculated (S104). Further, the curve function candidates respectively corresponding to the input value intercept candidates “c0”, “c1”, “c2”, . . . “cn” are acquired for the B component, and the square sum “Sj” of the errors of each of the curve function candidates is also calculated (S105).

The above processes for the G component and the B component are performed by calling again the common sub routine (FIGS. 6 and 7), which was called at the process (S103) for the R component. In any processes of S103 through S105 at which the sub routine is called, the input value intercept candidates “c0”, “c1”, “c2”, . . . “cn”, which are used in the sub routine, do not vary. In the above processes of S103 through S105, the curve function candidate and the square sum of the errors in the situation where the corresponding curve function candidate is used for approximation can be acquired with respect to each of the input value intercept candidates “c0”, “c1”, “c2”, . . . “cn”, and also, with respect to each of the RGB components.

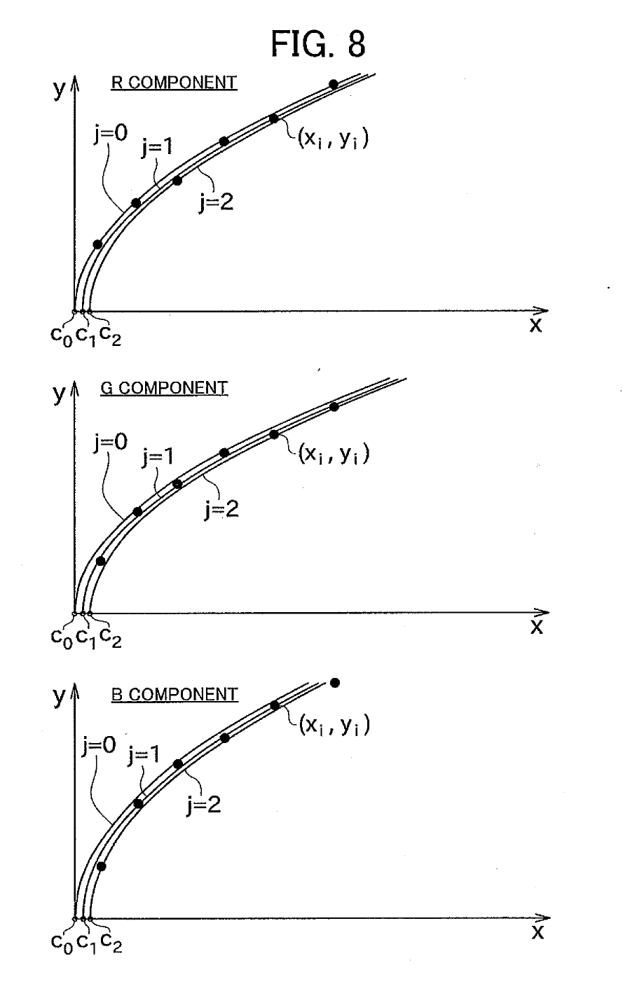

The above-described idea of acquiring the curve function candidates and calculating the errors will now be described with reference to FIG. 8. In FIG. 8, graphs of the RGB components are illustrated, and the sets (xi, yi) of the actual scanned tone values and the target tone values of the plurality of gray patches 91 are plotted with respect to each of the RGB components. Three curve function candidates of “j=0”, “j=1”, and “j=2” are illustrated as examples with respect to each of the RGB components.

Each of the three curve function candidates is acquired through the least-square method. The data (xi, yi) of the actual scanned tone value and the target tone value of each of the RGB components differs from each other. Therefore, the curve function candidate of each of the RGB components that is used to approximate the corresponding data also differs from each other.

Focusing on the input value intercepts, however, intercept values of the curve function candidates match with each other among the RGB components in any of the cases “j=0”, “j=1”, and “j=2”. More specifically, when “j=0”, the corresponding curve function candidates have the respective input value intercepts “c0”, and the values of the intercepts “c0” are equal in the graphs of the RGB components. Similarly, the input value intercepts “c1” in the case of “j=1” match with each other among the RGB components, and the input value intercepts “c2” in the case of “j=2” also match with each other among the RGB components. Accordingly, no matter which curve function candidate is adopted as the curve function, the input value intercept “c” of each of the curve functions can be common to the RGB components. As a result, tone correction that can faithfully reproduce the color especially in low-intensity tone can be achieved, and the scanned image can be acquired with good image quality.

After acquiring the curve function candidates and the square sums of the errors as described above, a sum “Tj” of the square sums “Sj” of the errors of the RGB components is acquired with respect to each of the input value intercept candidates “c0”, “c1”, “c2”, . . . “cn”, and then, “j” that derives a minimum sum “Tj” is acquired (i.e., comprehensively considering the RGB components, the number of the input value intercept candidate that derives the minimum disruption degree of the curve function candidate is acquired) (S106 of FIG. 3).

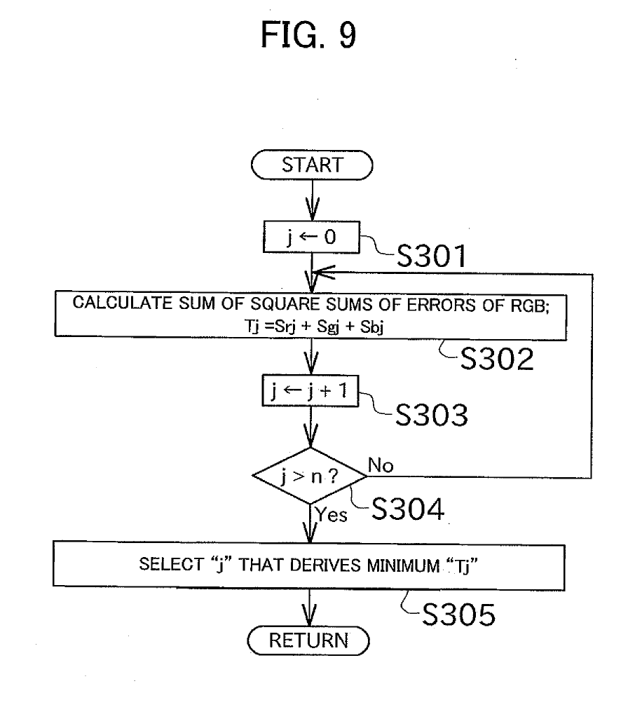

More specifically, the above process is achieved by calling the sub routine of FIG. 9 at S106. The flow is now described. First, the value of the loop variable “j” is initialized to zero (S301). Then, while increasing the value of “j” one by one from “0” to “n”, the sum “Tj” of the square sums “Sj” of the errors of the RGB components in the situation where the “j”th input value intercept candidate is used is acquired, and the acquired sum “Tj” is stored in a suitable storage unit (S302 through S304). By repeating this process, the sum “Tj” of the square sums of the errors of the RGB components can be acquired with respect to each of the cases “j=0”, “j=1”, . . . “j=n”. Then, by comparing the sums “Tj” with each other, the “j” that derives the minimum “Tj” is acquired (S305).

With the entire RGB components comprehensively considered, the input value intercept candidate “c” that derives the highest data approximation accuracy can be adopted from among the (n+1) input value intercept candidates “c0”, “c1”, “c2”, . . . “cn” by the above adding process and comparing process. The value of the input value intercept candidate “cj” that derives the highest approximation accuracy is stored in the correction function parameter storage unit 87 in the process of S305. The stored value of the input value intercept is used as the input value intercept “c” of the curve function (correction function) that is actually used in the tone correction. When the process of S305 is completed, the sub routine is ended.

Next, in S107 of the main routine (FIG. 3), the correction function parameter storage unit 87 stores the parameters “aj” and “bj” of the curve function candidate that corresponds to the input value intercept candidate “cj” that has been determined to have the highest data approximation accuracy. These parameters are used as parameters “a” and “b” of the curve function that is actually used in the tone correction. Thus, the main routine of the calibration operation is ended.

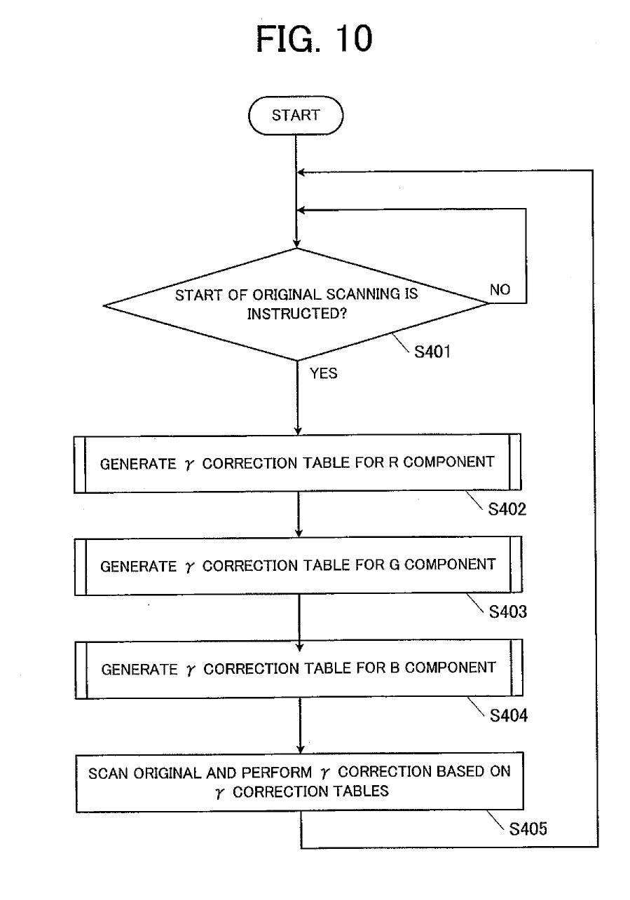

Next, a normal original scanning process performed after the completion of the above calibration operation is described with reference to FIG. 10. When the main flow of FIG. 10 is started, the control unit of the image scanner device 101 waits for the user to instruct the start of an original scanning operation (S401). When the user places a desired original on the image scanner device 101 and instructs the start of the scanning operation through the operation panel etc., the tone correction table for the R component is generated (S402).

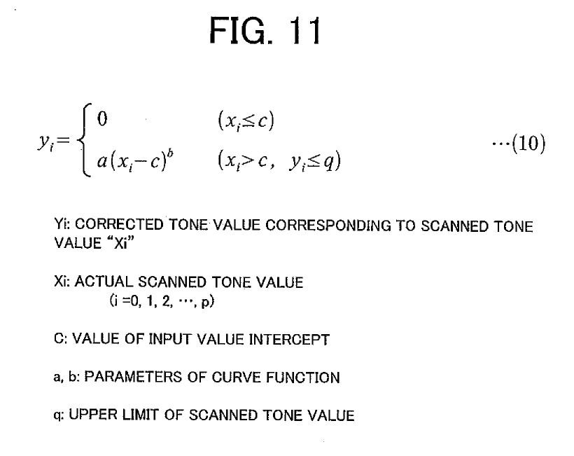

In the process of generating the tone correction table, the curve function represented in an equation (10) of FIG. 11 is used. The input value intercept candidate that has been determined to have the highest approximation accuracy in the calibration operation of FIG. 3 and the parameters of the curve function candidate that corresponds to the determined input value intercept candidate are used as the input value intercept “c” and the parameters “a” and “b” of the curve function of the equation (10). As described above, while the same value is used as the input value intercept “c” among the RGB components, different values are used as the parameters “a” and “b” among the RGB components.

In the present preferred embodiment, since each of the scanned tone values of the RGB components is output in eight bit format from the scanner unit 21, integer numbers 0 through 255 are assumed to be the actual scanned tone values (input values). Accordingly, in the present preferred embodiment, “xi=i”, and “p=255” (that is, xi=0, 1, 2, . . . , 255).

Further, a prescribed range is provided for the scanned tone values that can be output, and such range is taken into account in the equation (10). The image scanner device 101 according to the present preferred embodiment outputs a color image preferably in RGB each in 8 bit format, and each of the scanned tone values of the RGB components is limited to the range of 0 to 255. Therefore, the upper limit “q” of the equation (10) is set at 255.

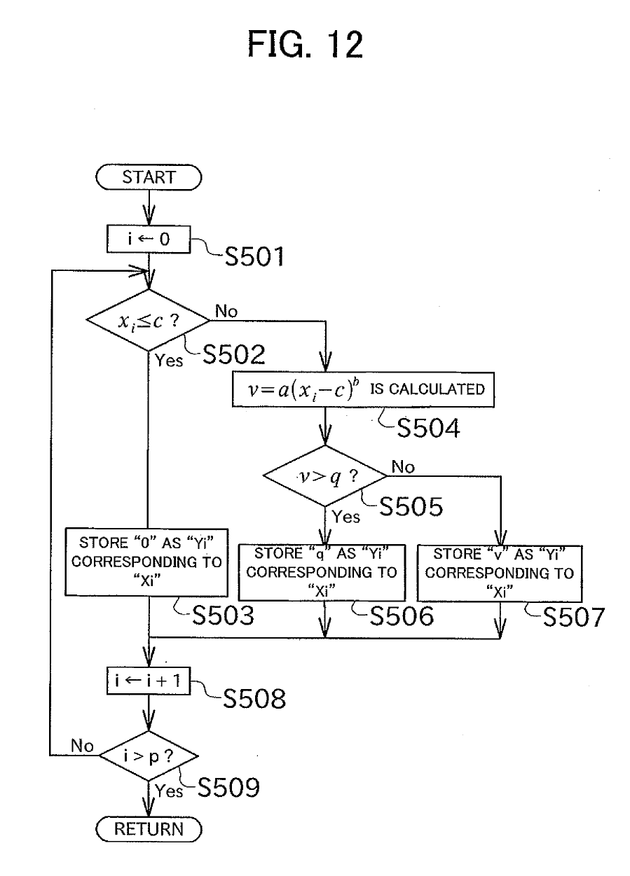

In the process of generating the tone correction table for the R component, more specifically, the table is generated by calling a sub routine of FIG. 12 at S402. Now, the sub routine of FIG. 12 will be described in detail. The sub routine is common to and can be called at steps S402 through S404.

A description will be made of the process of the subroutine performed when called at S402 of the main routine (i.e., when the tone correction table is generated for the scanned tone values of the R component). When the flow of FIG. 12 is started, first, the value of the loop variable “i” is initialized to zero (S501).

Then, the scanned tone value “xi” and the input value intercept “c” of the curve function (correction function) are compared (S502). When the scanned tone value “xi” is less than or equal to the input value intercept “c” of the curve function, “0” is stored as the output value “yi” that corresponds to the scanned tone value “xi” (S503).

When the scanned tone value “xi” exceeds the input value intercept “c” of the curve function, a value “v” is calculated by substituting the “xi” into an equation represented on a lower side of the curve function of the equation (10) of FIG. 11 (S504). Then, it is checked whether or not the acquired value “v” is greater than the output upper limit “q” (S505). As a result of the comparison, if the calculated value “v” exceeds the output upper limit “q”, the output upper limit “q” is stored as the output value “yi” that corresponds to the scanned tone value “xi” (S506). If the calculated value “v” is less than or equal to the output upper limit “q”, the calculated value “v” is stored as the output value “yi” that corresponds to the scanned tone value “xi” (S507).

Then, one is added to the value of the loop variable “i” (S508), and the processes of S502 through S508 are repeated until it is determined in S509 that the value of the loop variable “i” exceeds the number “p” of the scanned tone values. When it is determined that the value of the loop variable “i” exceeds the number of scanned tone values, the sub routine is ended.

Through the above processes, the tone correction table which stores sets of the original values (input values) “xi” and the corrected tone values (output value) “yi” is generated for the R component. The content of the generated tone correction table is stored in the tone correction table storage unit 45.

Then, step S403 of the main routine (FIG. 10) is executed, where the tone correction table for the G component is generated. Similarly to step S402, since the process is performed by calling the sub routine of FIG. 12, the description thereof is omitted. Further, the tone correction table for the B component is also generated (S404). Thus, the tone correction tables are generated for the respective RGB components and stored in the tone correction table storage unit 45.

Then, the original is scanned by the scanner unit 21, and the RGB tone values of the image data output from the scanner unit 21 are corrected based on the tone correction tables (S405).

Thus, since the curve functions (correction functions) for use in the tone correction tables in the present preferred embodiment share the same input value intercept “c” among the RGB components, a portion, especially in a low-intensity tone, of the image can be faithfully reproduced including gray balance. Moreover, without particularly increasing the number of gray patches 91 of low-intensity tone, calibration can be performed accurately and with excellent results. Further, generally, tone reproducibility of the scanner unit 21 produces exponential output characteristics with respect to the input, however, in the present preferred embodiment, since the curve function is used to approximate the output characteristics, even when the number of gray patches is small, the tone correction can be performed by accurately considering the characteristics of the scanner unit 21.

The scanned image after the tone correction is stored in the image memory 66, and then, coded by the code converting unit 69 and/or transmitted to a PC, or the like. Then, the control unit returns to step S401 and waits for a next instruction for an original scanning operation.

As described above, the image scanner device 101 according to the present preferred embodiment preferably includes the scanner unit 21, the patch tone value acquiring unit 82, the correction function acquiring unit 83, and the tone correction unit 46. The scanner unit 21 is arranged to scan the original. The patch tone value acquiring unit 82 is arranged to acquire the scanned tone values of each of the RGB components by scanning the gray patches 91 of the test chart 90, which includes the plurality of gray patches 91 each having the different tone. The correction function acquiring unit 83 is arranged to acquire the curve function with respect to each of the RGB components based on the scanned tone values and the target tone values of the gray patches 91 predetermined with respect to each of the RGB components, each curve function approximating the relationship between the input defined as the scanned tone values and the output defined as the target tone values. The tone correction unit 46 is arranged to correct the image (i.e., the RGB tone values of each pixel), which has been acquired by scanning the original by the scanner unit 21, by referring to the tone correction tables generated based on the curve functions. The correction function acquiring unit 83 is arranged to determine the curve function of each of the RGB components such that the input value intercepts “c”, each being defined as the upper limit of the range of the input value in which range the output value is maintained at zero, are common to the RGB components.

Since the input value intercepts “c” of the curve functions of the RGB components are common to the RGB components, the portion in a low-intensity tone of the image can be faithfully reproduced, with regard to the gray balance in particular. Moreover, without increasing the number of gray patches 91 the calibration operation can be achieved accurately and with excellent results, particularly at the portion in a low-intensity tone. Further, since the output characteristics of the scanner unit 21 can be accurately corrected by the curve functions, even when the number of gray patches 91 is small, the tone correction can be accurately performed.

In the image scanner device 101 according to the present preferred embodiment, the correction function acquiring unit 83 preferably includes the curve function candidate acquiring unit 84, the disruption degree acquiring unit 85, and the curve function determining unit 86. The curve function candidate acquiring unit 84 is arranged to acquire the curve function candidate with respect to each of the plurality of input value intercept candidates “c0”, “c1”, “c2”, . . . “cn” for each of the RGB components, each curve function candidate having the corresponding input value intercept candidate as the input value intercept. With respect to each of the plurality of input value intercept candidates “c0”, “c1”, “c2”, . . . “cn” for each of the RGB components, the disruption degree acquiring unit 85 is arranged to acquire the disruption degree in the situation where the corresponding curve function candidate is used to approximate the relationship between the scanned tone values and the target tone values of the gray patches 91. The curve function determining unit 86 is arranged to select the input value intercept candidate that derives the minimum disruption degree in the whole RGB components, and to determine the curve function candidate that corresponds to the selected input value intercept candidate as the curve function.

Thus, while matching the input value intercepts among the RGB components, the curve functions having the highest approximation accuracy can be acquired by comprehensively considering the RGB components. As a result, the quality of the scanned image can be further improved. Moreover, when the exponent function is used as the curve function as described in the present preferred embodiment, an approximation equation can be acquired in consideration of the reproducibility of the portion in a low-intensity tone.

In the image scanner device 101 according to the present preferred embodiment, the disruption degree acquiring unit 85 is arranged to acquire the square sum of the errors between the output values which are the scanned tone values of the gray patches 91 input into the curve function candidate and the target tone values of the gray patches 91 as the disruption degree.

Thus, the approximation accuracy of the curve function candidate with respect to the data acquired by scanning the gray patches 91 can be appropriately calculated and determined. Therefore, the most appropriate input value intercept candidate (curve function) can be reliably selected, and the scanned image faithfully reproducing the original can be acquired.

In the image scanner device 101 according to the present preferred embodiment, the curve function candidate acquiring unit 84 is preferably arranged to acquire the curve function candidate based on the scanned tone values of the gray patches 91 acquired by the patch tone value acquiring unit 82 and the target tone values of the gray patches 91 through the least-square method.

Thus, the scanned image faithfully reproducing the original can be acquired since the curve function with high accuracy can be acquired.

The disruption degree of the output values of the curve function candidate and the target tone values may be acquired with respect to only one predetermined component (hereinafter, referred to as a specified component) selected from the RGB components. This modified example will be described below. Since the functional block of the image scanner device of the modified example is similar to that of the above-described embodiment, reference numerals of FIG. 2 will be used below.

The image scanner device of the modified example preferably includes the correction function acquiring unit 83, and the correction function acquiring unit 83 includes the curve function candidate acquiring unit 84, the disruption degree acquiring unit 85, and the curve function determining unit 86.

The curve function candidate acquiring unit 84 is preferably arranged to acquire the curve function candidates corresponding to the respective input value intercept candidates “c0”, “c1”, “c2” with respect to, for example, only the G component (specified color component) of the RGB components through the least-square approximation. Similarly to the above preferred embodiment, the curve function candidates are exponent functions. The disruption degree acquiring unit 85 is arranged to calculate the disruption degree (for example, the square sum of the errors) of the output values of the corresponding curve function candidate and the target tone values with respect to each of the acquired curve function candidates for the G component.

The curve function determining unit 86 is arranged to select the input value intercept candidate that derives a minimum disruption degree, and to determine the curve function candidate that corresponds to the selected input value intercept candidate as the curve function for the G component. For other components (R component and B component), the curve function determining unit 86 is preferably arranged to acquire curve functions through the least-square approximation, for example, such that each of the curve functions for the other color components has the input value intercept of the curve function determined with respect to the G component (i.e., selected input value intercept candidate) as the input value intercept.

According to the modified example, while maintaining the approximation accuracy of the curve functions in the whole RGB components to some degree, the calculation process for the curve functions can be simplified compared with that of the above-described preferred embodiment.

As described above, the image scanner device of the modified example preferably includes the curve function determining unit 86. The curve function determining unit 86 is arranged to determine the curve function with respect to any one (G component) of the RGB components. The curve function determining unit 86 acquires the curve function for each of the R component and the B component such that each of the curve functions for the RB components has the input value intercept of the determined curve function as the input value intercept.

Thus, the curve functions having the same input value intercept among the RGB components can be acquired with a simple calculation process.

In the image scanner device according to the modified example, the curve function candidate acquiring unit 84 is arranged to acquire the curve function candidate with respect to each of the plurality of input value intercept candidates “c0”, “c1”, “c2” for any one (G component) of the RGB components, the curve function candidate having the input value intercept candidates c0, c1, c2, . . . , respectively, as the input value intercept. With respect to each of the plurality of input value intercept candidates “c0”, “c1”, “c2”, . . . for the G component, the disruption degree acquiring unit 85 is arranged to acquire the disruption degree in the situation where the corresponding curve function candidate is used to approximate the relationship of the scanned tone values and the target tone values of the patches. The curve function determining unit 86 is arranged to select the input value intercept candidate that derives the minimum disruption degree, and to determine the curve function candidate that corresponds to the selected input value intercept candidate as the curve function for the G component. The curve function determining unit 86 also acquires curve functions for the other components (R component and the B component) such that each of the curve functions for the other components has the selected input value intercept candidate as the input value intercept.

Thus, the curve function with the highest approximation accuracy can be acquired for the G component. Even when comprehensively considering the RGB components, the curve functions having the respective input value intercepts that are common to the RGB components and having good color reproducibility (such as gray balance) can be acquired by a simple calculation process.

Various preferred embodiments of the present invention have been described above, however, the above configuration may be modified, for example, as follows.

In the above preferred embodiments, after acquiring the curve function (correction function), the tone correction table is preferably generated as a look-up table based on the acquired curve function, and the tone correction unit 46 preferably corrects the scanned image based on the tone correction table. However, such a configuration is not limited to the tone correction table, and the scanned image may be corrected by directly using the curve function.

When scanning the original, the user may adjust brightness and contrast or the like of an image. In such a case the tone correction table may be generated after slightly adjusting the parameters of the curve function in accordance with user's instructions, and the scanned image may be corrected based on the tone correction table.

Instead of being generated at the start of the original scanning operation as described in the above preferred embodiment, the tone correction table may be generated at the time of calibration operation of FIG. 3.

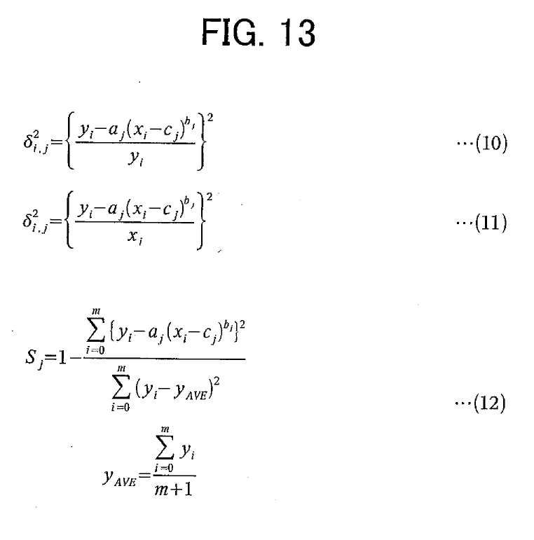

Instead of calculating with the equation of step S210 of FIG. 7, the error “δi, j²” (evaluation value of approximation accuracy) between the value corrected by the correction curve function candidate and the target tone value may be calculated through the equation (10) or (11) of FIG. 13. According to the equation (10) of FIG. 13, the approximation accuracy can be evaluated in consideration of largeness of the target tone value “yi”, and according to the equation (11), the approximation accuracy can be evaluated in consideration of largeness of the scanned tone value “xi”.

In step S213 of FIG. 7, instead of calculating the square sum of the errors as the disruption degree, the disruption degree defined in an equation (12) of FIG. 13, for example, may be calculated. Such disruption degree “Sj” is acquired as follows: the ratio between a square sum of errors in the situation where the target tone value “yi” is approximated by an arithmetic average “yAVE” of the target tone values “yi” and a square sum of errors in the situation where the target tone value “yi” is approximated by the output value of the curve function candidate is acquired, and then the ratio is subtracted from one.

Instead of acquiring the disruption degree between the output value of the curve function candidate and the target tone value with respect to each of the RGB components as represented in FIG. 3 and then adding such disruption degrees, a disruption degree of the entire RGB components may be calculated from the start.

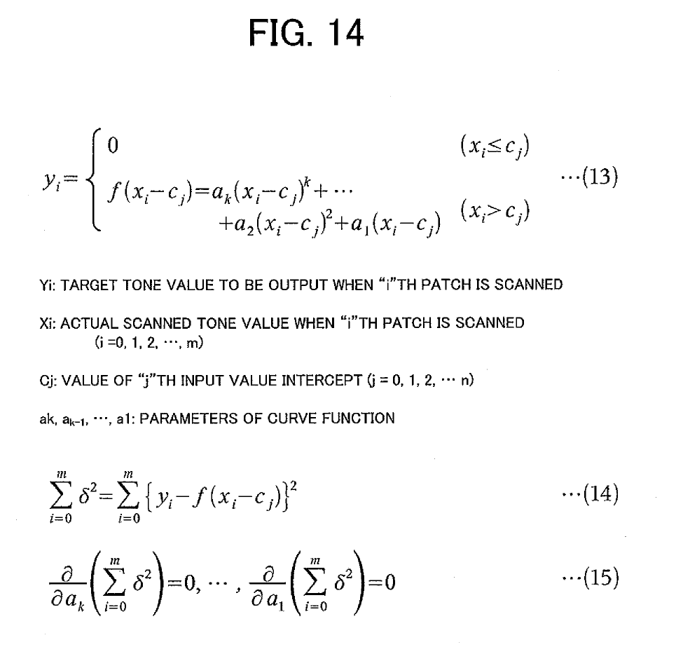

A form of the correction function is not limited as long as the correction function is represented as the curve function. For example, in place of the exponent function represented in the equation (10) of FIG. 11, a high-degree polynomial function may be used for approximation. An equation (13) of FIG. 14 represents that (m+1) sets of data (xi, yi) (i=0, 1, 2, . . . , m) are approximated by a k-degree polynomial function. A square sum of errors δ in the situation where the equation (13) is used for approximation is acquired by an equation (14). A value of the equation (14) partially differentiated with respect to each variable “ak”, “ak−1”, . . . is set at zero. Thus, simultaneous equations represented in an equation (15) can be obtained. By solving the simultaneous equations by a matrix, the parameters “ak”, “ak−1”, . . . “al” of the curve function can be acquired.

When using the polynomial function as described above, similarly to the above-described approximation using the exponent function, in order to determine the curve function, it is necessary to calculate the parameters “ak”, “ak−1”, . . . , “al” with respect to each of the (n+1) input value intercept candidates “cj” (from “c0” to “cn”), and then to calculate the disruption degree with respect to each of the curve function candidates.

Instead of scanning the image information of the original by separating the image information into the RGB colors, the scanning sensor 28 may scan the image information by separating the information into color components that are used in another color representation (for example, into Cyan, Magenta, and Yellow: CMY).

In place of the gray patches 91, patches other than gray may be used as the patches of the test chart 90.

The configurations of the above preferred embodiments and the modified examples are not limited to a stand-alone image scanner device 101, and may be applied to, for example, a copier or a Multi Functional Peripheral that is combined with an image forming unit that can form color images. In such a case, the test chart 90 printed by the image forming unit may be used. Similarly to the above preferred embodiments, a calibration operation that excels particularly in low-intensity tone reproducibility (gray balance) can be achieved.

While the present invention has been described with respect to preferred embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. An image scanning device comprising:
a scanning unit arranged to scan an original;
a patch tone value acquiring unit arranged to acquire scanned tone values of a plurality patches each having a different tone with respect to each of a plurality of color components when an original used for calibration including the patches is scanned by the scanning unit;
a correction function acquiring unit arranged to:
acquire a curve function with respect to each of the plurality of color components based on the scanned tone values and target tone values of the patches predetermined with respect to each of the plurality of color components, each curve function approximating a relationship between an input defined as the scanned tone value and an output defined as the target tone value; and
determine the curve function of each of the plurality of color components such that input value intercepts, each being defined as an upper limit of a range of the input value in which range the output value is maintained at zero, are equal among the plurality of color components; and
a correction unit arranged to use the determined curve functions to correct the tone values of each of the plurality of color components of an image acquired by the scanning unit by scanning the original.

2. The image scanning device according to claim 1, wherein the correction function acquiring unit includes a curve function determining unit arranged to determine a curve function with respect to a specified color component which is any one of the plurality of color components, and to acquire curve functions with respect to the color components other than the specified color component such that each of the curve functions for the other color components has the input value intercept of the determined curve function as the input value intercept.

3. The image scanning device according to claim 2, wherein the correction function acquiring unit includes:
a curve function candidate acquiring unit arranged to acquire a curve function candidate with respect to each of a plurality of input value intercept candidates for the specified color component which is any one of the plurality of color components, each curve function candidate having the corresponding input value intercept candidate as the input value intercept;
a disruption degree acquiring unit arranged to acquire, with respect to each of the plurality of input value intercept candidates for the specified color component, a disruption degree in a situation where the corresponding curve function candidate is used to approximate the relationship between the scanned tone values and the target tone values of the patches; and
a curve function determining unit arranged to:
select the input value intercept candidate that derives a minimum disruption degree;
determine the curve function candidate corresponding to the selected input value intercept candidate as the curve function for the specified color component; and
acquire curve functions with respect to the color components other than the specified color component such that each of the curve functions for the other color components has the selected input value intercept candidate as the input value intercept.

4. The image scanning device according to claim 1, wherein the correction function acquiring unit further includes:
a curve function candidate acquiring unit arranged to acquire a curve function candidate with respect to each of a plurality of input value intercept candidates for each of the plurality of color components, each curve function candidate having the corresponding input value intercept candidate as the input value intercept;
a disruption degree acquiring unit arranged to acquire, with respect to each of the plurality of input value intercept candidates for each of the plurality of color components, a disruption degree in a situation where the corresponding curve function candidate is used to approximate the relationship between the scanned tone values and the target tone values of the patches; and
a curve function determining unit arranged to:
select the input value intercept candidate that derives a minimum disruption degree in all of the plurality of color components; and
determine the curve function candidate corresponding to the selected input value intercept candidate as the curve function.

5. The image scanning device according to claim 3, wherein the disruption degree acquiring unit is arranged to acquire:
a square sum of errors between the output values, which are the scanned tone values of the patches input to the curve function candidate, as the disruption degree; and
the target tone values of the patches.

6. The image scanning device according to claim 3, wherein the curve function candidate acquiring unit is arranged to acquire the curve function candidate through a least square method based on the target tone values of the patches and the scanned tone values of the patches acquired by the patch tone value acquiring unit.

7. An image scanning device comprising:
a scanning device arranged to scan an original;
an acquiring device arranged to acquire scanned tone values of a plurality of patches each having a different tone with respect to each of a plurality of color components when an original for use in calibration including the plurality of patches is scanned by the scanning device;
a curve acquiring device arranged to acquire a curve function with respect to each of the plurality of color components based on target tone values of the patches predetermined with respect to each of the plurality of color components and based on the scanned tone values, each curve function approximating a relationship between an input defined as the scanned tone value and an output defined as the target tone value, and then to determine the curve function of each of the plurality of color components such that input value intercepts, each being defined as an upper limit of a range of the input value in which range the output value is maintained at zero, are equal among the plurality of color components; and
a correcting device arranged to use the determined curve functions to correct the tone value of each of the plurality of color components of an image acquired by scanning the original.

8. The image scanning device according to claim 7, further comprising a determining device arranged to determine a curve function with respect to a specified color component which is any one of the plurality of color components, and then, to acquire curve functions with respect to the color components other than the specified color component such that each of the curve functions for the other color components has the input value intercept of the determined curve function as the input value intercept.

9. The image scanning device according to claim 8, further comprising:
a curve function acquiring device arranged to acquire a curve function candidate with respect to each of a plurality of input value intercept candidates for the specified color component which is any one of the plurality of color components, each curve function candidate having the corresponding input value intercept candidate as the input value intercept;
a disruption degree acquiring device arranged to acquire a disruption degree in a situation where the corresponding curve function candidate is used to approximate the relationship between the scanned tone values and the target tone values of the patches with respect to each of the plurality of input value intercept candidates for the specified color component; and
a selecting device arranged to select the input value intercept candidate that derives a minimum disruption degree, to determine the curve function candidate corresponding to the selected input value intercept candidate as the curve function for the specified color component, and to acquire curve functions with respect to the color components other than the specified color component such that each of the curve functions for the other color components has the selected input value intercept candidate as the input value intercept.

10. The image scanning device according to claim 7, further comprising:
a curve function acquiring device arranged to acquire a curve function candidate with respect to each of the plurality of input value intercept candidates for each of the plurality of color components, each curve function candidate having the corresponding input value intercept candidate as the input value intercept;
a disruption degree acquiring device arranged to acquire, with respect to each of the plurality of input value intercept candidates for each of the plurality of color components, a disruption degree in a situation where the corresponding curve function candidate is used to approximate the relationship between the scanned tone values and the target tone values of the patches; and
a selecting device arranged to select the input value intercept candidate that derives a minimum disruption degree in all of the plurality of color components, and then, to determine the curve function candidate corresponding to the selected input value intercept candidate as the curve function.

11. The image scanning device according to claim 9, wherein the disruption degree acquiring device is arranged to acquire a square sum of errors between the output values, which are the scanned tone values of the patches input to the curve function candidate, and the target tone values of the patches as the disruption degree.

12. The image scanning device according to claim 9, wherein the curve function acquiring device is arranged to acquire a curve function candidate through a least square method based on the scanned tone values of the patches and the target tone values of the patches.

13. A calibration method of an image scanning device, the method comprising the steps of:
scanning an original used in calibration including a plurality of patches each having a different tone;
acquiring scanned tone values of the patches of the original used in calibration with respect to each of a plurality of color components;
acquiring a curve function with respect to each of the plurality of color components based on the scanned tone values and target tone values of the patches predetermined with respect to each of the plurality of color components, each curve function approximating a relationship between an input defined as the scanned tone value and an output defined as the target tone value; and
determining the curve function of each of the plurality of color components such that input value intercepts, each being defined as an upper limit of a range of the input value in which range the output value is maintained at zero, are equal among the plurality of color components.

14. The calibration method of the image scanning device according to claim 13, the method further comprising the steps of:
determining a curve function with respect to a specified color component which is any one of the plurality of color components; and
acquiring curve functions with respect to the color components other than the specified color component such that each of the curve functions for the other color components has the input value intercept of the determined curve function as the input value intercept.

15. The calibration method of the image scanning device according to claim 14, the method further comprising the steps of:
acquiring a curve function candidate with respect to each of a plurality of input value intercept candidates for the specified color component which is any one of the plurality of color components, each curve function candidate having the corresponding input value intercept candidate as the input value intercept;
acquiring a disruption degree in a situation where the corresponding curve function candidate is used to approximate the relationship between the scanned tone values and the target tone values of the patches with respect to each of the plurality of input value intercept candidates for the specified color component;
selecting the input value intercept candidate that derives a minimum disruption degree;
determining the curve function candidate corresponding to the selected input value intercept candidate as the curve function for the specified color component; and
acquiring curve functions with respect to the color components other than the specified color component such that each of the curve functions for the other color components has the selected input value intercept candidate as the input value intercept.

16. The calibration method of the image scanning device according to claim 13, the method further comprising the steps of:
acquiring a curve function candidate with respect to each of the plurality of input value intercept candidates for each of the plurality of color components, each curve function candidate having the corresponding input value intercept candidate as the input value intercept;
acquiring a disruption degree in a situation where the corresponding curve function candidate is used to approximate the relationship between the scanned tone values and the target tone values of the patches with respect to each of the plurality of input value intercept candidates for each of the plurality of color components;
selecting the input value intercept candidate that derives a minimum disruption degree in all of the plurality of color components; and
determining the curve function candidate corresponding to the selected input value intercept candidate as the curve function.

17. The calibration method of the image scanning device according to claim 15, further comprising the step of acquiring, as the disruption degree, a square sum of errors between the output values, which are the scanned tone values of the patches input to the curve function candidate and the target tone values of the patches.

18. The calibration method of the image scanning device according to claim 15, further comprising the step of acquiring the curve function candidate through a least square method based on the scanned tone values of the patches and the target tone values of the patches.
